(19) United States
(12) Patent Application Publication
(10) Pub. No.: US 2025/0266858 A1
(43) Pub. Date: Aug. 21, 2025

(54) ACOUSTIC WAVE TRANSMITTING/RECEIVING DEVICE AND METHOD OF CONSTRUCTING THE SAME

(71) Applicant: NEC Corporation, Tokyo (JP)

(72) Inventor: Kazuhiko HASEBE, Tokyo (JP)

(73) Assignee: NEC Corporation, Tokyo (JP)

(21) Appl. No.: 19/049,156

(22) Filed: Feb. 10, 2025

(30) Foreign Application Priority Data
Feb. 19, 2024 (JP) 2024-023282

(51) Int. Cl. H04B 1/40; H04B 11/00

(52) U.S. Cl. CPC H04B 1/40; H04B 11/00

(57) ABSTRACT

An acoustic wave transmitting/receiving device according to the present disclosure includes a driving element having a first end and a second end, a front mass having a side surface and a hole, the front mass being connected to the first end, and a rear mass connected to the second end, in which the hole extends from the side surface into the front mass.

### CROSS-REFERENCE TO RELATED APPLICATION

Priority is claimed on Japanese Patent Application No. 2024-023282, filed Feb. 19, 2024, the content of which is incorporated herein by reference.

### BACKGROUND ART

This disclosure relates to an acoustic wave transmitting/receiving device and a method of constructing an acoustic wave transmitting/receiving device.

As an acoustic wave transmitting/receiving device, an acoustic wave transmitting/receiving device equipped with a front mass is known.

As this type of acoustic wave transmitting/receiving device, Japanese Unexamined Patent Application, First Publication No. 2006-20018 (hereinafter referred to as Patent Document 1) discloses a bolt-fastened Langevin type transducer.

### SUMMARY

In the transducer disclosed in Patent Document 1, a front mass of a Langevin type vibrator is provided with a slit on a circumference of a lower portion on a rear mass side, the slit communicating with an axial center from an outer peripheral side surface.

However, in the transducer as disclosed in Patent Document 1, it may be difficult to perform slit processing on the front mass.

For this reason, it may be difficult to perform processing of the front mass.

An example object of the present disclosure is to provide an acoustic wave transmitting/receiving device and a method of constructing the acoustic wave transmitting/receiving device for solving the above-mentioned problems.

An acoustic wave transmitting/receiving device according to one example aspect of the present disclosure includes a driving element having a first end and a second end, a front mass having a side surface and a hole, the front mass being connected to the first end, and a rear mass connected to the second end, in which the hole extends from the side surface into the front mass.

A method of constructing an acoustic wave transmitting/receiving device according to one example aspect of the present disclosure includes forming a hole extending from a side surface of a front mass into the front mass, installing the front mass at a first end of a driving element, and installing a rear mass at a second end of the driving element.

### BRIEF DESCRIPTION OF DRAWINGS

FIG. 1 is a front view of an acoustic wave transmitting/receiving device according to the present disclosure.

FIG. 2 is a side view of FIG. 1.

FIG. 3 is a cross-sectional view along line III-III in FIG. 2.

FIG. 4 is a front view of the acoustic wave transmitting/receiving device according to the present disclosure.

FIG. 5 is a side view of FIG. 4.

FIG. 6 is a cross-sectional view along line VI-VI in FIG. 5.

FIG. 7 is a front view of the acoustic wave transmitting/receiving device according to the present disclosure.

FIG. 8 is a front view of the acoustic wave transmitting/receiving device according to the present disclosure.

FIG. 9 is a front view of the acoustic wave transmitting/receiving device according to the present disclosure.

FIG. 10 is a front view of the acoustic wave transmitting/receiving device according to the present disclosure.

FIG. 11 is a side view of FIG. 10.

FIG. 12 is a side view of the acoustic wave transmitting/receiving device according to the present disclosure.

FIG. 13 is a flowchart showing steps of a method of constructing the acoustic wave transmitting/receiving device according to the present disclosure.

### EXAMPLE EMBODIMENT

Several example embodiments will be described below with reference to the drawings. The same or corresponding components in all drawings will be given the same reference numerals, and repeat descriptions will be omitted.

In the present disclosure, the drawings relate to one or more example embodiments.

An acoustic wave transmitting/receiving device according to the present disclosure will be described below with reference to FIGS. 1 to 3.

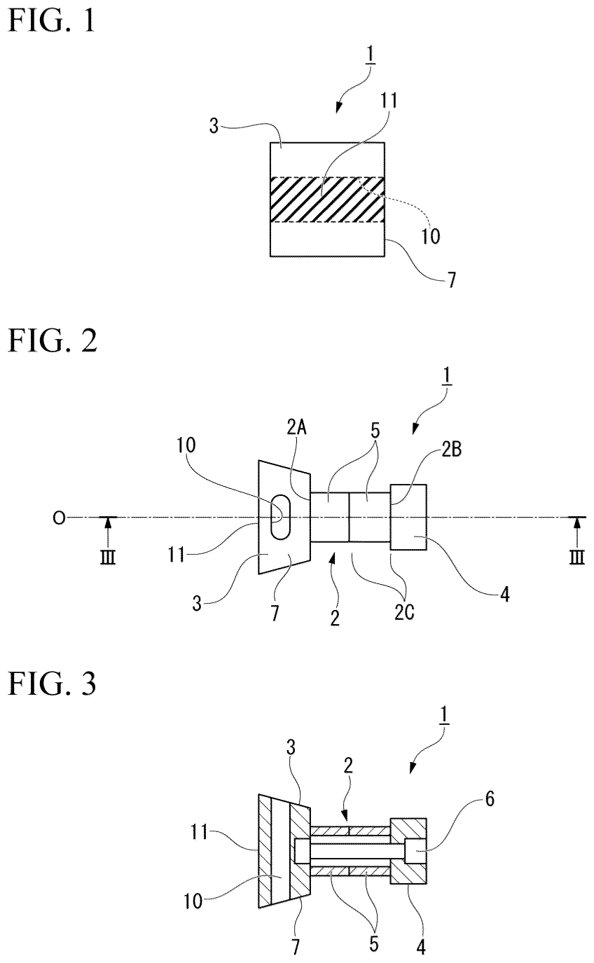

FIGS. 1 to 3 are schematic diagrams of an acoustic wave transmitting/receiving device 1 according to the present disclosure, in which FIG. 1 is a front view, FIG. 2 is a side view, and FIG. 3 is a cross-sectional view taken along line III-III in FIG. 2.

As shown in FIG. 2, the acoustic wave transmitting/receiving device 1 includes a driving element 2 which is a Langevin type wave transmitting/receiving element.

The driving element 2 includes a first end 2A and a second end 2B and is configured such that a front mass 3 is connected to the first end 2A and a rear mass 4 is connected to the second end 2B.

In addition, the driving element 2 is a cylindrical piezoelectric element 5 made of PZT (lead titanate zirconate) or the like with electrodes 2C on both ends thereof, and is driven by an AC voltage supplied from a driving circuit (not shown).

The driving element 2 is configured such that a plurality of cylindrical piezoelectric elements 5 are connected along a central axis O.

The front mass 3 is made of a lightweight material such as an aluminum alloy.

The rear mass 4 is made of a dense material such as steel.

The front mass 3 and the rear mass 4 are connected to the cylindrical driving element 2 by tightening a bolt 6 that passes through the driving element 2 as shown in FIG. 3.

In a case where the bolt 6 that couples the front mass 3 and the rear mass 4 together is tightened, compressive stress is applied to the driving element 2 from both sides, generating vibrations with a certain frequency.

The front mass 3 is rectangular as viewed from the front (the left side in FIG. 2 along the central axis O of the driving element 2) as shown in FIG. 1, and has a hole 10 that penetrates from one side surface 7 to the opposite side.

The hole 10 extends as an opening having a certain size and shape in the front mass 3 in a direction perpendicular to the central axis O of the driving element 2.

In addition, the hole 10 is formed by cutting from the side surface 7 of the front mass 3 into the front mass 3.

Furthermore, the hole 10 is formed in an elongated hole shape (see FIG. 2), but the shape is not limited.

In addition, a bending vibration plate 11 is provided on the front side of the front mass 3.

As viewed from the front of the front mass 3 (from the left side in FIG. 2), the bending vibration plate 11 is formed in a portion (shown by diagonal lines in FIG. 1) which is an upper portion of the hole 10 as shown in FIG. 1.

The bending vibration plate 11 is a portion of a material that configures the front mass 3, and vibration occurs in a case where the center portion of the bending vibration plate 11 is greatly displaced in a bending vibration mode.

It is preferable that the hole 10 and the bending vibration plate 11 be formed in a positional relationship that is symmetrical to the central axis O of the driving element 2, and in this example, they are formed linearly to be centered on the central axis O and to be perpendicular to the central axis O as shown in FIG. 1.

In addition, the front of the front mass 3 is in contact with an acoustic medium such as water or seawater via a sealing material (not shown) such as natural rubber or urethane for watertightness.

The vibration of the front mass 3 is radiated as sound waves to an acoustic medium such as water through a sealing material.

In the acoustic wave transmitting/receiving device 1 configured as described above, the front mass 3 has the hollow hole 10, and thus the upper portion of the hole 10 (the shaded portion in FIG. 1) serves as a bending vibration plate 11 and vibrates in a bending vibration mode in which the center portion of the bending vibration plate 11 is greatly displaced.

That is, in the acoustic wave transmitting/receiving device 1, in a case where a voltage is applied from a drive circuit (not shown) to excite the piezoelectric element 5, the center portion of the front mass 3 vibrates greatly due to bending vibration at a frequency in the bending vibration mode.

Here, the vibration generated in the bending vibration plate 11 of the front mass 3 is radiated as sound waves to an acoustic medium such as water via a sealing material such as rubber.

Further, in the acoustic wave transmitting/receiving device 1, the hole 10 is provided on the side surface 7 of the front mass 3 so as to extend into the front mass 3, which makes it easy to process the hole 10.

Thus, the acoustic wave transmitting/receiving device 1 makes it easy to process the front mass 3.

Further, in the acoustic wave transmitting/receiving device 1, the position of the hole 10 can be appropriately adjusted on the side surface 7 of the front mass 3, and thus high sensitivity wave transmission and reception can be performed at a resonance frequency in the length direction of a wave transmitting/receiving element and a resonance frequency of bending vibration.

Further, in the acoustic wave transmitting/receiving device 1, the position of the hole 10 in the front mass 3 is appropriately adjusted, and thus it is possible to adjust the respective frequencies to be particularly close and to be within approximately one octave of each other and to achieve high transmission and reception sensitivity over a wide band by superimposing modes.

Further, in the acoustic wave transmitting/receiving device 1, it is possible to arbitrarily set the resonance frequency of the bending vibration depending on the shape and position of the hole 10.

Additionally, in the acoustic wave transmitting/receiving device 1, the bending vibration plate 11 is in contact with the side surface 7 that is the outer periphery of the front mass 3 and has a shape that allows access to the cavity of the hole 10 from the side surface 7, and thus the front mass 3 can be manufactured integrally with the bending vibration plate 11 by cutting.

The acoustic wave transmitting/receiving device 1 can also be manufactured by lamination shaping.

In addition, the acoustic wave transmitting/receiving device 1 has a shape in which the hole 10 extending inward is provided on the side surface 7 of the front mass 3, and thus it is possible to remove powder, a support material, and the like from the hole 10 in the side surface 7 after molding.

Further, the acoustic wave transmitting/receiving device 1 has a shape in which the hole 10 extending inward is provided on the side surface 7 of the front mass 3, and thus a joining process such as welding or bonding is not required during manufacturing, making it possible to manufacture the acoustic wave transmitting/receiving device 1 with high precision and curb variations in the resonance frequency of bending vibration.

Further, in the acoustic wave transmitting/receiving device 1, there is no possibility of a decrease in the strength of a joint due to a welding defect or the like, and there is no need to inspect a joint condition.

The above-mentioned several example embodiments can be modified as follows.

### Modification Example 1

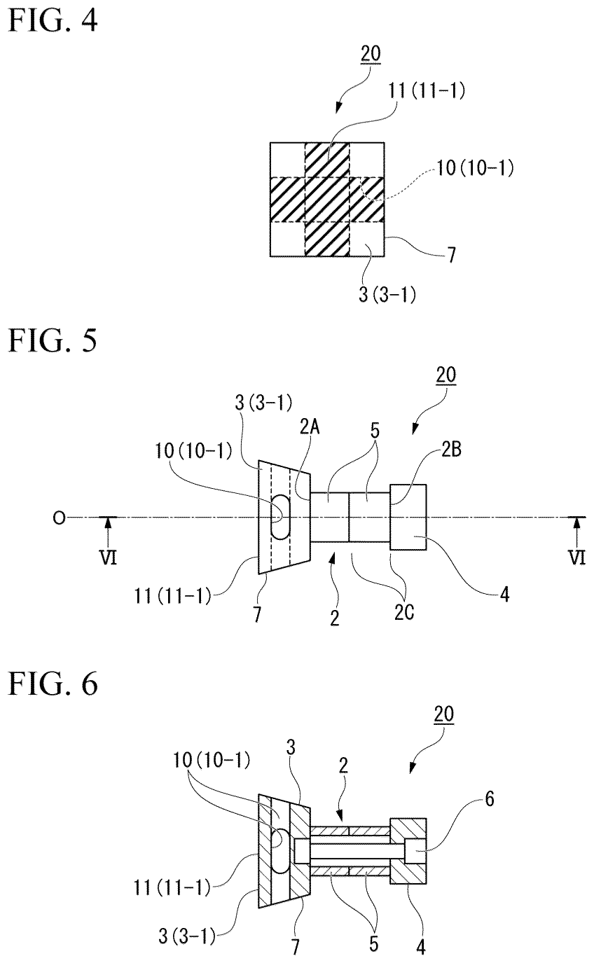

In the above-mentioned several example embodiments, an example of a Langevin type wave transmitting/receiving element in which the front mass 3 and the rear mass 4 are connected to the driving element 2 by fastening the bolt 6 that passes through the driving element 2 is shown, but the present disclosure may also be applied to a Langevin type vibrator that is not fastened with bolts, as shown in FIGS. 4 to 6.

That is, an acoustic wave transmitting/receiving device 20 shown in these drawings is configured such that the front mass 3 (indicated by a symbol 3-1), the driving element 2, and the rear mass 4 are joined together by a method such as bonding, rather than by bolt fastening. In such an acoustic wave transmitting/receiving device 20, the rear mass 4 may be omitted as appropriate.

Similarly to the acoustic wave transmitting/receiving device 1, in the acoustic wave transmitting/receiving device 20, the hole 10 is provided in the side surface 7 of the front mass 3, making it easy to process the hole 10.

Further, in the acoustic wave transmitting/receiving device 20, the position of the hole 10 can be appropriately adjusted on the side surface 7 of the front mass 3, and thus high sensitivity wave transmission and reception can be performed at a resonance frequency in the length direction of a wave transmitting/receiving element and a resonance frequency of bending vibration.

### Modification Example 2

Although the bending vibration plate 11 and the hole 10 related to the bending vibration plate 1 are formed in a positional relationship that is symmetrical to the central axis O of the driving element 2 in the above-mentioned several example embodiments, they are not limited to being formed linearly (see FIG. 1), and may be formed in an X-shape around the central axis O as shown in FIG. 4.

The bending vibration plate 11 and the hole 10 formed in an X-shape are shown by reference numerals 11-1 and 10-1 in FIGS. 4 to 6, respectively.

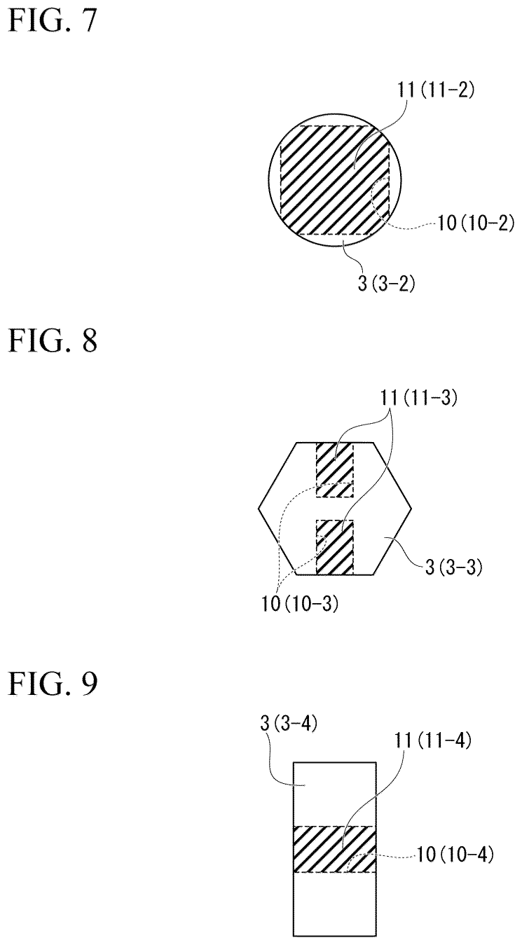

In addition, the bending vibration plate 11 and the hole 10 may occupy most of the front mass 3 as shown by reference numerals 11-2 and 10-2 in the front view of FIG. 7, respectively.

### Modification Example 3

Although the front shape of the front mass 3 is formed in a square shape as shown in FIGS. 1 and 4 in the above-mentioned several example embodiments, this is not limiting, and various shapes such as a circle as shown by reference numeral 3-2 in FIG. 7, a hexagon as shown by reference numeral 3-3 in FIG. 8, and an octagon can be used.

### Modification Example 4

Although a piezoelectric element 5 configured with a piezoelectric ceramic stacked body or the like is used as the driving element 2 in the above-mentioned several example embodiments, this is not limiting, and anything that can convert electrical signals and mechanical vibrations, such as a magnetostrictive vibrator or a voice coil, can be used.

### Modification Example 5

Although the hole 10 is disposed perpendicular to the side surface 7 of the front mass 3 as shown in FIGS. 1 to 3 and FIGS. 4 to 6 in the above-mentioned several example embodiments, this is not limiting, and the hole 10 may be disposed at any angle on the side surface 7 of the front mass 3.

Although the hole 10 is disposed to penetrate the front mass 3 as shown in FIGS. 1 to 3 and FIGS. 4 to 6 in the above-mentioned several example embodiments, this is not limiting, and the hole may be formed not to penetrate the front mass 3 and to have an end portion within the front mass 3 as shown by reference numeral 10-3 in FIG. 8.

In the example embodiment shown in FIG. 8, the bending vibration plate 11 is provided to be divided in the middle thereof as shown by reference numeral 11-3 in response to the hole 10-3.

### Modification Example 6

Although the hole 10 and the bending vibration plate 11 (see FIG. 1) that are approximately ⅓ the size of the front area of the front mass 3 are provided in the above-mentioned several example embodiments, this is not limiting, and a linear bending vibration plate 11 and a hole 10 related to the bending vibration plate 11 that are small in the vertical direction relative to a front mass 3-4 may also be used as shown by reference numerals 11-4 and 10-4 in FIG. 9.

Thereby, in the acoustic wave transmitting/receiving device shown in FIG. 9, directivity in a specific direction (vertical direction in this example) can be reduced at a frequency of bending vibration.

### Modification Example 7

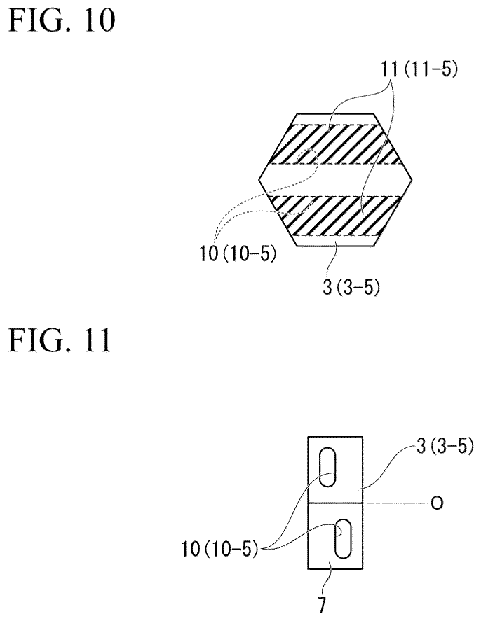

In the above-mentioned several example embodiments, a plurality of holes 10 may be provided on the side surface 7 of the front mass 3 as shown by reference numeral 10-5 in FIGS. 10 and 11, and these holes 10 may be disposed at positions that are shifted not to pass through the central axis O.

In the acoustic wave transmitting/receiving device shown in FIGS. 10 and 11, the front mass 3 (shown by reference numeral 3-5) having the bending vibration plate 11 (shown by reference numeral 11-5) in which the position of the hole 10 is changed with respect to the central axis O is used, and thus it is possible to provide resonance frequencies in a plurality of bending vibration modes and to further widen a bandwidth.

In addition, the shapes of the bending vibration plate 11 (11-5) and the hole 10 (10-5) are also appropriately changed together with the above-mentioned positions thereof, and thus it is possible to further obtain resonance frequencies in various bending vibration modes.

### Modification Example 8

In the above-mentioned several example embodiments, the hole 10 is an elongated cavity. That is, the peripheral surface of the hole 10 includes a curved surface. However, the shape of the hole 10 is not limited to such a shape.

As a modification example, the hole 10 may be a square hole-shaped cavity. That is, the peripheral surface of the hole 10 may be a combination of flat surfaces.

As another modification example, the hole 10 may be a circular hole-cavity.

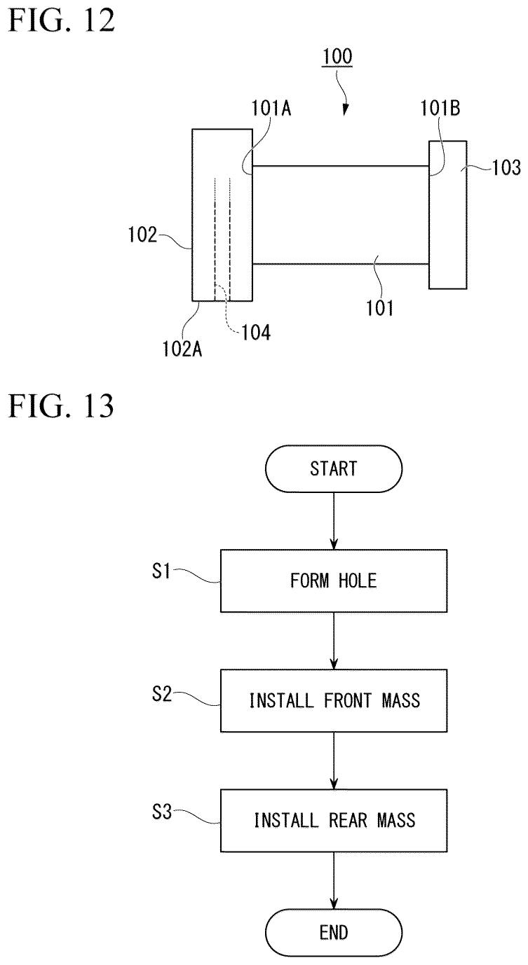

The acoustic wave transmitting/receiving device according to the present disclosure will be described below with reference to FIG. 12.

FIG. 12 shows an acoustic wave transmitting/receiving device 100 that includes a driving element 101, a front mass 102, and a rear mass 103.

The driving element 101 has a first end 101A and a second end 101B.

The front mass 102 is connected to the first end 101A of the driving element 101 and has a hole 104 in its side surface 102A.

The rear mass 103 is connected to the second end 101B of the driving element 101.

The hole 104 in the front mass 102 is configured to extend from the side surface 102A of the front mass 102 into the front mass 102.

According to the acoustic wave transmitting/receiving device 100 as described above, the hole 104 extending into the front mass 102 is provided on the side surface 102A of the front mass 102, making it easy to process the hole 104.

Thus, according to the acoustic wave transmitting/receiving device 100 described above, it is easy to process the front mass 102.

A method of constructing the acoustic wave transmitting/receiving device according to the present disclosure will be described below with reference to FIGS. 1 to 3 and FIG. 13.

FIG. 13 is a flowchart showing steps of the method of constructing the acoustic wave transmitting/receiving device 1.

### [Step S1]

A worker forms the hole 10 that extends from one side surface 7 of the front mass 3 into the front mass 3. The hole 10 is formed by performing cutting from the side surface 7 of the front mass 3 into the front mass 3.

The worker also provides the bending vibration plate 11 related to the position of the hole 10 on the surface of the front mass 3.

### [Step S2]

The worker connects the front mass 3 processed in step S1 to the first end 2A of the driving element 2, which is a Langevin type wave transmitting/receiving element.

At that time, the hole 10 is configured to extend as an opening having a certain size and shape in the front mass 3 in a direction perpendicular to the central axis O of the driving element 2.

### [Step S3]

The worker connects the rear mass 4 to the second end 2B of the driving element 2. The front mass 3 and the rear mass 4 are connected by fastening the bolt 6 that passes through the driving element 2.

In the above-mentioned method of constructing the acoustic wave transmitting/receiving device 1, the hole 10 is provided on the side surface 7 of the front mass 3 to extend into the front mass 3, making it easy to process the hole 10.

Thus, according to the above-mentioned method of constructing the acoustic wave transmitting/receiving device, it is easy to process the front mass 3.

In addition, according to the above-mentioned method of constructing the acoustic wave transmitting/receiving device 1, the position of the hole 10 can be appropriately adjusted on the side surface 7 of the front mass 3, and thus high sensitivity wave transmission and reception can be performed at a resonance frequency in the length direction of a wave transmitting/receiving element and a resonance frequency of bending vibration.

The hole 10 may be formed as a cavity extending as an opening having a certain size and shape, and the hole 10 may be formed as an elongated cavity. In addition, the hole 10 may be formed as a through cavity reaching the opposite side surface of the front mass 3, or may be formed as a non-through cavity having an end inside the front mass 3. A plurality of holes 10 may be provided inside the front mass 3 (see FIG. 8).

The bending vibration plate 11 and the hole 10 can be disposed at positions shifted from the central axis O, in addition to being formed in a linear or rectangular shape as viewed from the front in a direction along the central axis O or being formed in an X-shape (see FIGS. 4 to 11).

A method of constructing the acoustic wave transmitting/receiving device according to the present disclosure will be described below with reference to FIG. 13.

FIG. 13 is a flowchart showing steps of the method of constructing the acoustic wave transmitting/receiving device.

### [Step S1]

A hole extending one side surface of the front mass to the inside is formed.

### [Step S2]

The front mass is connected to the first end of the driving element, which is a wave transmitting/receiving element.

### [Step S3]

The rear mass is connected to the second end of the driving element.

In the above-mentioned method of constructing the acoustic wave transmitting/receiving device, the hole extending into the front mass is provided on the side surface of the front mass, making it easy to process the hole.

Thus, according to the above-mentioned method of constructing the acoustic wave transmitting/receiving device, it is easy to process the front mass.

Although the present disclosure has been described above with reference to several example embodiments, the present disclosure is not limited to the several example embodiments described above. Various modifications that can be understood by a person skilled in the art can be made to the configuration and details of the present disclosure within the scope of the present disclosure. Furthermore, each example embodiment can be appropriately combined with other example embodiments.

According to the above-mentioned aspect, it is easy to process the front mass.

Some or all of the above-mentioned example embodiments may be described as in the following supplementary notes, but are not limited to the following.

(Supplementary Note 1)

An acoustic wave transmitting/receiving device including:
a driving element having a first end and a second end;
a front mass having a side surface and a hole, the front mass being connected to the first end; and
a rear mass connected to the second end,
wherein the hole extends from the side surface into the front mass.

(Supplementary Note) 2)

The acoustic wave transmitting/receiving device according to Supplementary Note 1, wherein the hole is a cavity extending with a constant size and a constant shape.

(Supplementary Note) 3)

The acoustic wave transmitting/receiving device according to Supplementary Note 1 or 2, wherein the hole is an elongated cavity.

(Supplementary Note 4)

The acoustic wave transmitting/receiving device according to any one of Supplementary Notes 1 to 3, wherein the hole is a through cavity that reaches an opposite side surface of the front mass.

(Supplementary Note 5)

The acoustic wave transmitting/receiving device according to any one of Supplementary Notes 1 to 4, wherein the hole is a non-through cavity having an end inside the front mass.

(Supplementary Note 6)

The acoustic wave transmitting/receiving device according to any one of Supplementary Notes 1 to 5, wherein the hole includes a plurality of holes provided in the front mass.

(Supplementary Note 7)

The acoustic wave transmitting/receiving device according to any one of Supplementary Notes 1 to 6, wherein the front mass includes a bending vibration plate forming the hole and a surface of the front mass.

(Supplementary Note 8)

The acoustic wave transmitting/receiving device according to any one of Supplementary Notes 1 to 7, wherein the hole is cut from the side surface into the front mass.

(Supplementary Note 9)

The acoustic wave transmitting/receiving device according to any one of Supplementary Notes 1 to 8, wherein the hole includes a plurality of holes disposed in a positional relationship symmetrical to a central axis of the driving element.

(Supplementary Note 10)

The acoustic wave transmitting/receiving device according to Supplementary Note 7, wherein the bending vibration plate and the hole have a linear shape as viewed from a front in a direction along a central axis of the driving element.

(Supplementary Note 11)

The acoustic wave transmitting/receiving device according to Supplementary Note 7, wherein the bending vibration plate and the hole have a rectangular shape as viewed in a direction along a central axis of the driving element.

(Supplementary Note 12)

The acoustic wave transmitting/receiving device according to Supplementary Note 7, wherein the bending vibration plate and the hole have an X-shape as viewed in a direction along a central axis of the driving element.

(Supplementary Note 13)

The acoustic wave transmitting/receiving device according to any one of Supplementary Notes 1 to 12, wherein the hole includes a plurality of holes which are provided inside the front mass and are disposed at positions shifted from a central axis of the driving element.

(Supplementary Note 14)

A method of constructing an acoustic wave transmitting/receiving device, the method including:
forming a hole extending from a side surface of a front mass into the front mass;
installing the front mass at a first end of a driving element; and
installing a rear mass at a second end of the driving element.

(Supplementary Note 15)

The method of constructing the acoustic wave transmitting/receiving device according to Supplementary Note 14, wherein the forming includes forming the hole by performing cutting from the side surface into the front mass.

(Supplementary Note 16)

The method of constructing the acoustic wave transmitting/receiving device according to Supplementary Note 14 or 15, wherein the forming includes forming the hole in a positional relationship symmetrical to a central axis of the driving element.

(Supplementary Note 17)

The method of constructing the acoustic wave transmitting/receiving device according to any one of Supplementary Notes 14 to 16, wherein the hole is a cavity extending a constant size and a constant shape.

(Supplementary Note 18)

The method of constructing the acoustic wave transmitting/receiving device according to any one of Supplementary Notes 14 to 17, wherein the hole is an elongated cavity.

(Supplementary Note 19)

The method of constructing the acoustic wave transmitting/receiving device according to any one of Supplementary Notes 14 to 18, wherein the hole is a through cavity that reaches an opposite side surface of the front mass.

(Supplementary Note 20)

The method of constructing the acoustic wave transmitting/receiving device according to any one of Supplementary Notes 14 to 19, wherein the hole is a non-through cavity having an end inside the front mass.

(Supplementary Note 21)

The method of constructing the acoustic wave transmitting/receiving device according to any one of Supplementary Notes 14 to 20, wherein the hole includes a plurality of holes provided in the front mass.

(Supplementary Note 22)

The method of constructing the acoustic wave transmitting/receiving device according to any one of Supplementary Notes 14 to 21, wherein the front mass includes a bending vibration plate forming the hole and a surface of the front mass.

(Supplementary Note 23)

The method of constructing the acoustic wave transmitting/receiving device according to Supplementary Note 22, wherein the bending vibration plate and the hole are formed linearly as viewed from a front in a direction along a central axis of the driving element.

(Supplementary Note 24)

The method of constructing the acoustic wave transmitting/receiving device according to Supplementary Note 22, wherein the bending vibration plate and the hole are formed in a rectangular shape as viewed from a direction along a central axis of the driving element.

(Supplementary Note 25)

The method of constructing the acoustic wave transmitting/receiving device according to Supplementary Note 22, wherein the bending vibration plate and the hole are formed in a cross shape as viewed from a direction along a central axis of the driving element.

(Supplementary Note 26)

The method of constructing the acoustic wave transmitting/receiving device according to any one of Supplementary Notes 14 to 25, wherein the hole includes a plurality of holes which are provided inside the front mass and are disposed at positions shifted from a central axis of the driving element.

What is claimed is:

1. An acoustic wave transmitting/receiving device comprising:
a driving element having a first end and a second end;
a front mass having a side surface and a hole, the front mass being connected to the first end; and
a rear mass connected to the second end,
wherein the hole extends from the side surface into the front mass.

2. The acoustic wave transmitting/receiving device according to claim 1, wherein the hole is a cavity extending with a constant size and a constant shape.

3. The acoustic wave transmitting/receiving device according to claim 2, wherein the hole is an elongated cavity.

4. The acoustic wave transmitting/receiving device according to claim 1, wherein the hole is a through cavity that reaches an opposite side surface of the front mass.

5. The acoustic wave transmitting/receiving device according to claim 1, wherein the hole is a non-through cavity having an end inside the front mass.

6. The acoustic wave transmitting/receiving device according to claim 1, wherein the hole includes a plurality of holes provided in the front mass.

7. The acoustic wave transmitting/receiving device according to claim 1, wherein the front mass includes a bending vibration plate forming the hole and a surface of the front mass.

8. The acoustic wave transmitting/receiving device according to claim 1, wherein the hole includes a plurality of holes disposed in a positional relationship symmetrical to a central axis of the driving element.

9. The acoustic wave transmitting/receiving device according to claim 7, wherein the bending vibration plate and the hole have a linear shape as viewed from a front in a direction along a central axis of the driving element.

10. The acoustic wave transmitting/receiving device according to claim 7, wherein the bending vibration plate and the hole have a rectangular shape as viewed in a direction along a central axis of the driving element.

11. The acoustic wave transmitting/receiving device according to claim 7, wherein the bending vibration plate and the hole have an X-shape as viewed in a direction along a central axis of the driving element.

12. The acoustic wave transmitting/receiving device according to claim 1, wherein the hole includes a plurality of holes which are provided inside the front mass and are disposed at positions shifted from a central axis of the driving element.

13. A method of constructing an acoustic wave transmitting/receiving device, the method comprising:
forming a hole extending from a side surface of a front mass into the front mass;
installing the front mass at a first end of a driving element; and
installing a rear mass at a second end of the driving element.

14. The method of constructing the acoustic wave transmitting/receiving device according to claim 13, wherein the forming includes forming the hole by performing cutting from the side surface into the front mass.
